(19) United States
(12) Patent Application Publication
(10) Pub. No.: US 2023/0243210 A1
(43) Pub. Date: Aug. 3, 2023

(54) Method of Making a Mesh Security Screen

(71) Applicant: Qulok IP Pty Ltd, Cleveland (AU)

(72) Inventor: Beau Blakemore, Cleveland (AU)

(21) Appl. No.: 18/105,800

(22) Filed: Feb. 3, 2023

(30) Foreign Application Priority Data
Feb. 3, 2022 (AU) 2022900205

(51) Int. Cl. E06B 9/01

(52) U.S. Cl. CPC E06B 9/01

(57) ABSTRACT

A new form of mesh security screen is disclosed. The mesh security screen has a frame and grille which are pressed together. The frame and grille are held in place with indentations through the frame and into the grille to permanently connect the grille to the frame.

### BACKGROUND OF THE INVENTION

### 1. Field of the Invention

The present invention relates to the security screen industry and, more particularly to a method of quickly constructing a strong mesh security screen for doors or windows.

### 2. Description of the Related Art

As shown in FIG. 1, a prior art mesh security screen 10 comprises a grille 12 and frame 14. The grille 12 is joined to the frame 14 by rivets 16.

A problem with this prior art method of construction is that it is time consuming to drill all the holes 18 in the frame 14 for the rivets 16. Another problem is that the rivets 16 form a relatively weak connection between the grille 12 and the frame 14.

Other prior art methods of constructing mesh security screens 10 involve welding the grille 12 to the frame 14 or crimping the edge of the frame 14 over the grille 12.

However, welding requires surface rectification and coating after construction. Welding consumes further time and involves additional labour which increases the cost of production. Furthermore, welding is considered dangerous in most workshops.

Crimping only provides a low joint strength between the frame 14 and the grille 12. Crimping also leaves visually distorted edges on the frame 14.

The object of the present invention is to provide a faster, stronger and cheaper method of constructing mesh security screens.

### SUMMARY OF THE INVENTION

According to a first aspect of the present invention, there is provided a method of making a mesh security screen, the method comprising the steps of:
(a) assembling a frame for the security screen;
(b) preparing a grille for the security screen;
(c) cutting a groove into the grille;
(d) inserting the grille into the frame; and
(e) pressing indentations through the frame into the groove of the grille to permanently connect the grille to the frame.

According to a second aspect of the present invention, there is provided a mesh security screen comprising:
(a) a frame for the security screen;
(b) a grille for the security screen;
(c) a groove in the grille; and
(d) a pressed indentation through the frame into the groove in the grille to permanently connect the grille to the frame.

The grille could be a diamond shaped grille, a decorative panel, a cast panel, or an expanded mesh, for example. The mesh security screen may include a fly screen over the grille.

Any of the features described herein can be combined in any combination with any one or more of the other features described herein within the scope of the invention.

### BRIEF DESCRIPTION OF THE DRAWINGS

Embodiments of the invention will be described with reference to the following drawings, in which:

FIG. 1 is a perspective view of a prior art security screen comprising rivets to hold a grille to a frame.

FIG. 2 is a front view of a security screen according to an embodiment of the present invention.

FIG. 3 is a perspective view of a grille used in the security screen of FIG. 2.

FIG. 4 is a perspective view of a frame used in the security screen of FIG. 2.

FIG. 5 is a side view of a press tool making an indentation through the frame of FIG. 4 into the grille of FIG. 3.

FIG. 6 is a perspective view of the press tool of FIG. 5 making an indentation through the frame of FIG. 4 into the grille of FIG. 3.

### DETAILED DESCRIPTION OF THE INVENTION

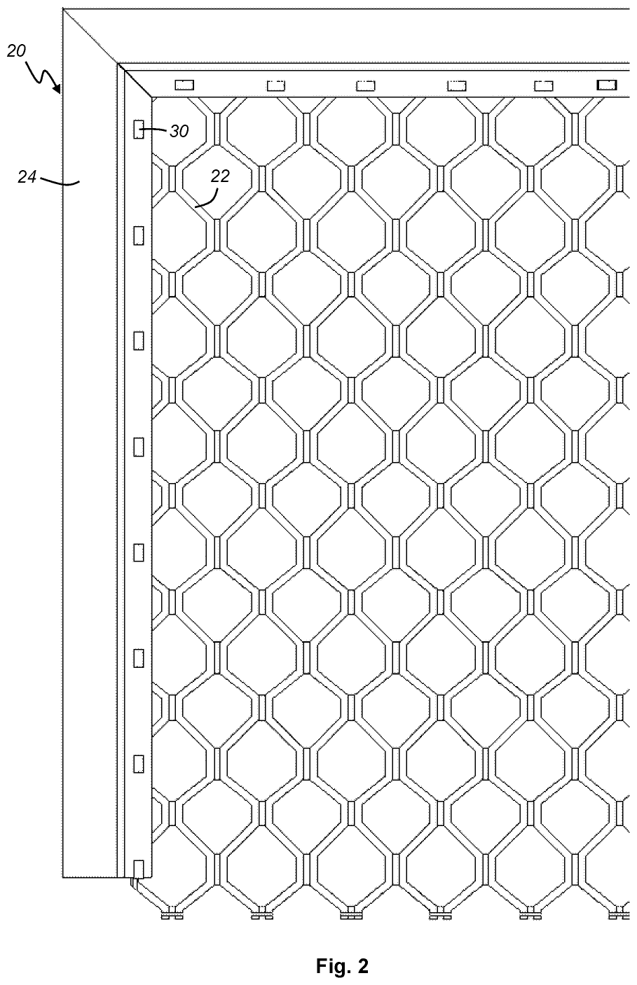

FIG. 2 shows an assembled mesh security screen 20 according to an embodiment of the present invention.

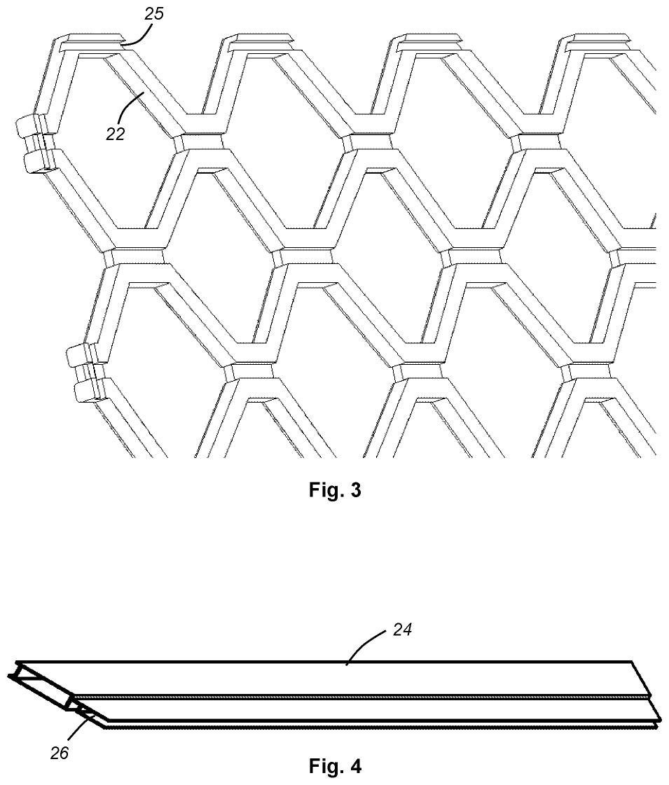

The mesh security screen 20 comprises a grille 22 (see FIG. 3) and frame 24 (see FIG. 4). The grille 22 has a groove 25, which is cut into the grille 22 with a specialised saw (not shown).

The saw is a circular saw with guides and blades that are customised to suit the dimensions of the grille and cut the grooves 25 at the correct spacing and depth.

A diamond shaped grille is shown in FIGS. 2 to 6. However, different grilles are within the scope and ambit of the invention, such as a decorative panel, a cast panel, or an expanded mesh, for example. The mesh security screen 20 may include a fly screen over the grille.

The frame 24 has a slot 26 adapted to fit the grille 22. The grille 22 is inserted into the slot 26 in each edge of the frame 24 around the grille 22.

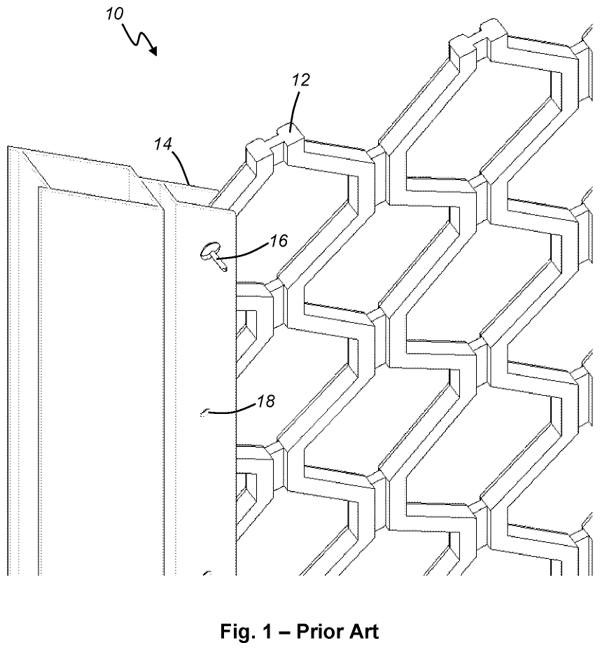

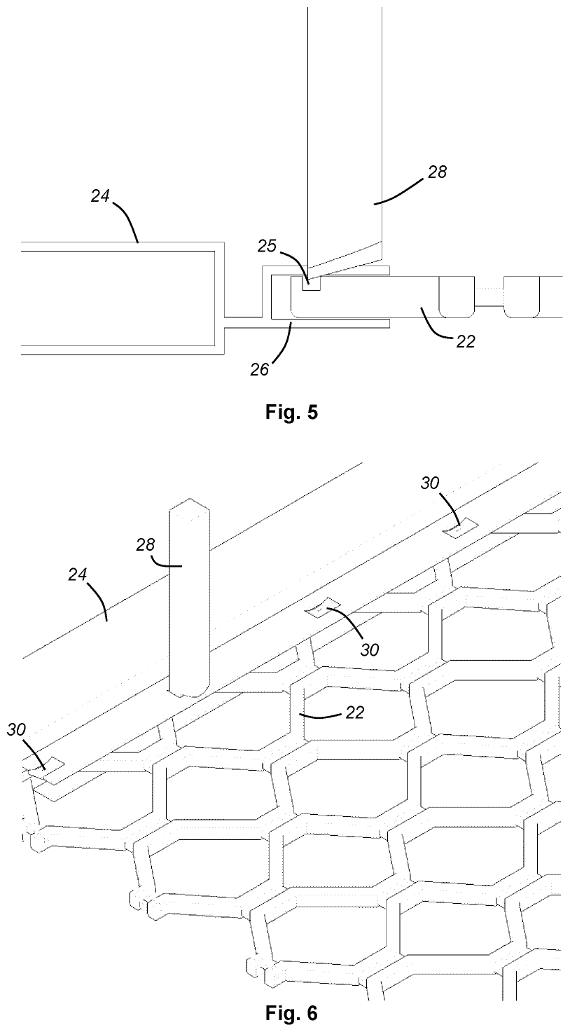

FIG. 5 shows a press tool 28 which is held in an Arbor press (not shown). The press tool 28 operates in a downward motion to indent the edge of the frame 24 into the grille 22. The indentations 30 form a permanent connection between the frame 24 and the grille 22. The press tool 28 has a slanted edge which presses foremost into the groove 25, leaving a joint which cannot easily be retracted. This permanent connection is tamper proof. By contrast, the rivets 16 (see FIG. 1) can be drilled out of the prior art security screen 10 so that a burglar can gain access to a property.

The indented connections 30 also form a strong bond, which is easier to make and less dangerous than welding. The indented connections 30 are also less time consuming than making rivet connections and much stronger.

The present invention thereby provides a faster, stronger and cheaper method of constructing mesh security screens.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method of making a mesh security screen, the method comprising:
(a) assembling a frame for the security screen;
(b) preparing a grille for the security screen;
(c) cutting a groove into the grille;
(d) inserting the grille into the frame; and
(e) pressing indentations through the frame into the groove of the grille to permanently connect the grille to the frame.

2. A mesh security screen comprising:
(a) a frame for the security screen;
(b) a grille for the security screen;
(c) a groove in the grille; and
(d) a pressed indentation through the frame into the groove in the grille, wherein the pressed indentation permanently connects the grille to the frame.
